(19) United States
(12) Patent Application Publication
(10) Pub. No.: US 2008/0067129 A1
(43) Pub. Date: Mar. 20, 2008

(54) INHIBITION OF PARAFFIN WALL DEPOSITION IN OIL LINES

(75) Inventors: MICHAEL JUENKE, SPRING, TX (US); LAWRENCE RZEZNIK, SPRING, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: WEATHERFORD/LAMB, INC., HOUSTON, TX (US)

(21) Appl. No.: 11/531,994

(22) Filed: Sep. 14, 2006

(51) Int. Cl. C02F 1/48

(52) U.S. Cl. 210/695; 210/696; 210/748; 204/554; 208/24; 166/305.1

(57) ABSTRACT

Disclosed herein is a method for treating hydrocarbon fluids to inhibit the deposition of paraffin compounds on the interior of pipes and other surfaces. The method includes injecting a catalyst fluid containing scale forming compounds into the hydrocarbon fluid. The scale forming compounds may be calcium carbonate, calcium bicarbonate, calcium, bicarbonate barium sulfate, or other compounds/ingredients. The catalyst fluid may be an aqueous or non-aqueous solution. The method further includes inducing an electromagnetic field in the fluid so as to cause the formation of seed crystals from the scale forming compounds. The paraffin will then adhere to the seed crystals, i.e., scale particles. The resulting particles can then be filtered out or otherwise removed from the solution. Paraffin deposition on the interior of pipes and other surfaces is therefore inhibited. Also disclosed herein are hydrocarbon wells and other piping systems constructed to take advantage of the described techniques.

### BACKGROUND

Oil wells, flowlines, and pipelines experience reduced flow or increased pressure as a result of paraffin dropping out of solution from the flowing crude oil or hydrocarbon fluid and coating the walls of the piping system. Wax that has deposited has historically been removed by heating the wax above the cloud point, mechanically scraping the line with a poly pig or cutter, or injecting chemicals or solvents. Wax crystal modifiers to prevent wax formation below the cloud point of the fluid. Significant cost is incurred to heat the line, to scrape the line clean using a pipeline pig or mechanical cutter, or to use chemicals that inhibit wax deposition.

It has been determined that certain radio frequency (RF) electromagnetic devices designed for the prevention of scale formation in water carrying conduits will also prevent wax deposition in oil piping systems that also carry an aqueous phase with chemical components for scale formation. Examples of such electromagnetic devices are described in U.S. Pat. Nos. 5,514,283; 5,667,677; and 5,935,433, all to Stefanini, each of which is hereby incorporated by reference in its entirety. The general principle of operation of such devices is as follows. A primary coil is mounted on the exterior of the pipe. An electronic circuit energizes the primary coil to generate a succession of radio frequency signals. The signals form a varying or pulsed electromagnetic field in the fluid within the pipe. The field has generally circular flux lines that are generally co-axial with the pipe, and propagate along the length of the pipe. The primary coil and electronic circuit may take a variety of forms designed so as to provide an optimal electromagnetic field for a given application.

Other devices based on magnetism and/or magnetic fields generated by either permanent magnets or electromagnets are also available to prevent paraffin deposition. Additionally, there are devices based on piezoelectric crystal technology that can be used for paraffin treatment. Each of these various types of electric, magnetic, and/or electromagnetic field based devices should be included in the term “electromagnetic treatment devices” as used herein.

However, a problem with such devices arises in that they are unable to prevent wax deposition if the fluid is pure hydrocarbon, i.e., lacking an aqueous phase, and the scale crystals or chemical components are not present. Therefore, what is needed in the art is a technique for allowing these electromagnetic devices to be used in oil wells, flowlines, and pipelines that are lacking an aqueous phase and/or the required scale crystals.

### SUMMARY

Disclosed herein is a method for treating hydrocarbon fluids to inhibit the deposition of paraffin compounds on the interior of pipes and other surfaces. The method includes injecting a catalyst fluid containing scale forming compounds into the hydrocarbon fluid. The scale forming compounds may be calcium carbonate, calcium bicarbonate, calcium, bicarbonate barium sulfate, or other compounds/ingredients. The catalyst fluid may be an aqueous or non-aqueous solution. The method further includes inducing an electromagnetic field in the fluid so as to cause the formation of seed crystals from the scale forming compounds. The paraffin will then adhere to the seed crystals, i.e., scale particles. The resulting particles can then be filtered out or otherwise removed from the solution. Paraffin deposition on the interior of pipes and other surfaces is therefore inhibited. Also disclosed herein are hydrocarbon wells and other piping systems constructed to take advantage of the described techniques.

Additional details and information regarding the disclosed subject matter can be found in the following description and drawings.

### BRIEF DESCRIPTION OF THE DRAWINGS

FIG. 1 schematically illustrates an oil well incorporating certain teachings of the present disclosure.

FIG. 2 schematically illustrates a pipeline or flowline incorporating certain teachings of the present disclosure.

### DETAILED DESCRIPTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and sub goals (e.g., compliance with system and technical constraints), which will vary from one implementation to another. Moreover, attention will necessarily be paid to proper engineering and programming practices for the environment in question. It will be appreciated that such a development effort might be complex and time-consuming, but would nevertheless be a routine undertaking for those of ordinary skill in the relevant fields.

In this description, the terms “up” and “down”; “upward” and “downward”; “upstream” and “downstream”; and other like terms indicating relative positions above or below a given point or element may be used to clearly describe some embodiments of the invention. However, when applied to apparatus and methods for use in wells that are deviated or horizontal, such terms may refer to a left-to-right, right-to-left, or other relationship as appropriate.

Electromagnetic treatment devices as described above are electronic, physical treatment devices. In general, the devices create an electric, magnetic, and/or electromagnetic field that causes scale to form in solution rather than plate on the walls of the pipe. It has been determined that in hydrocarbon solutions containing paraffin and other wax-like substances, these crystals of scale also act as sites for the paraffin to adhere rather than depositing on the walls of the pipe. Because scale must be present for such devices to prevent wax deposition, in wells or pipelines that do not include scale forming compounds, injection of such compounds permits the use of electromagnetic treatment devices to prevent paraffin deposition. Chemical injection is generally known in the art, but a simplified description is described below.

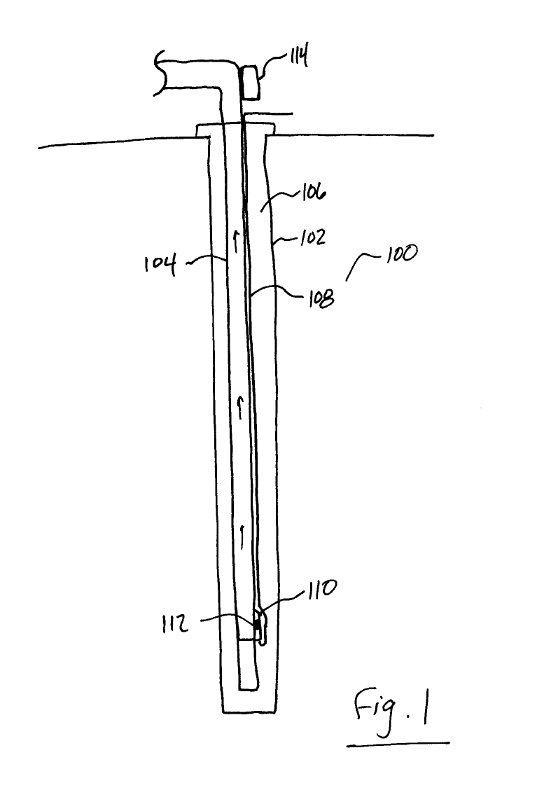

An exemplary embodiment for use in an oil well is illustrated schematically in FIG. 1. Oil well 100 includes a casing 102. Within the casing, production tubing string 104 provides the avenue for the production of hydrocarbons, which may include a mixture of oil and/or natural gas. An annular space 106 is defined by the casing 102 and the production tubing string 104. A chemical injection line 108 is run from the surface along the outside of the production tubing string 104 within the annular space 106. This chemical injection line 108 originates at a high pressure pump (not shown) capable of generating pressure sufficient to overcome the wellbore pressure at depth. Chemical injection line 108 terminates at a chemical injection mandrel 110 that includes a chemical injection valve 112. A variety of such mandrels and valves are known to those skilled in the art and are readily available from numerous manufacturers. CI Series Injection Mandrels, Subs, and Valves produced by Weatherford International are suitable for use in connection with the systems described herein.

In a typical chemical injection installation, chemical injection mandrel 110 with chemical injection valve 112 is installed as part of the production tubing string 104. Chemical injection line 108 is run from the chemical injection mandrel 110 to the surface to act as a conduit for the injected fluid. Reverse-flow check valves (not shown) are installed at the point of injection to prevent flow from the production tubing entering the injection flow path. A high-pressure pump, capable of overcoming the downhole pressure, is installed on the surface to pump the chemical injection fluid to the injection point. Furthermore, one or more injection points may be provided along the production tubing.

At the injection point (or points), the chemical injection components are used to introduce a solution containing scale forming compounds into the well. This solution, which may be known as a catalyst fluid, may take a variety of forms. Among such fluids are aqueous solutions of calcium, carbonate, bicarbonate, calcium carbonate, and/or calcium bicarbonate. Barium sulfide in aqueous solution may also be used. A variety of other scale forming chemicals, in both aqueous or non-aqueous solution, will also be apparent to those skilled in the art. The essential property of such compounds is that they be capable of forming seed crystals of scale in the presence of electromagnetic fields induced by electromagnetic treatment device 114, which is connected to the production tubing at the surface. These seed crystals give the wax a site to adhere that otherwise would not be present, thereby preventing the wax from depositing on the walls of the pipe.

The wax, thus effectively suspended in the production hydrocarbons, may be removed at the surface or terminus. One mechanism of paraffin removal is filtration. Alternatively, the paraffin deposits will typically float on top of the produced hyrdrocarbons, and thus the production hydrocarbons may be drawn off the bottom of a suitable tank or settling basin. Either technique provides substantial cost and complexity savings over the prior art techniques of paraffin removal from the production tubing, which were discussed above.

Alternatively, it is not necessary to include chemical injection line 108. For example, the catalyst fluid may be injected directly into the well annulus. When annular injecting it is generally preferred to coat the surfaces exposed in the annulus and to inject greater quantities of catalyst fluid at first. As will be appreciated by one skilled in the art, this type injection is used successfully throughout the oilfield for various treating applications.

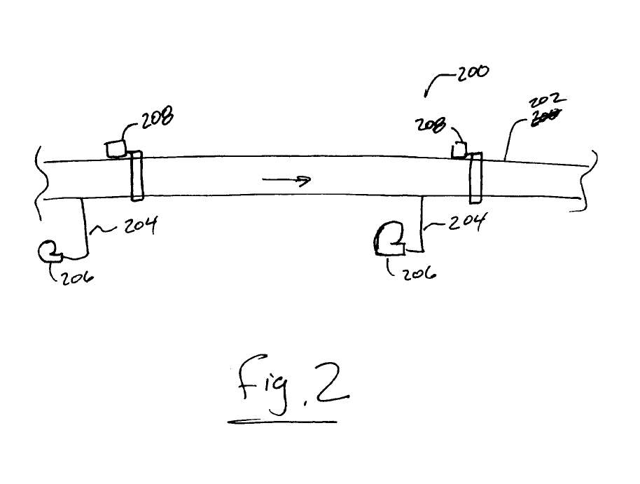

Additionally, the techniques disclosed herein are not limited to oil wells. Flowlines and pipelines may be treated in similar fashion. For example, FIG. 2 illustrates a flowline or pipeline 200, comprising pipe 202. Flow of hydrocarbons in the pipeline is illustrated by the directional arrow. One or more chemical injection lines 204 allow catalyst fluid, as described above, to be injected into the pipeline. The pumps 206 that inject the catalyst fluid may be any of a variety of pump types that are able meet the catalyst fluid flow requirements at the pipeline pressure. One skilled in the art will find it a routine undertaking to select such a pump. One or more electromagnetic treatment devices 208 may be disposed along the pipe, as taught in the incorporated references. As in the well embodiment, the wax particles that form around the seed crystals may be removed at the destination by filtration or other suitable techniques.

One skilled in the art will appreciate that the amount of catalyst fluid and the concentration of scale forming compounds therein would be determined as a function of the hydrocarbon fluid volume being treated and the amount of paraffin forming hydrocarbon therein.

When using a treatment device as described in the Stefanini patents referenced above, the nominal operation frequency of the device is about 200 kHz. Other details of operation may be gathered from the Clearwell International Specifier's Guide, which is incorporated by reference in its entirety.

Although specific embodiments and variations of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations that may have been suggested in the present disclosure, may be made to the disclosed embodiments without departing from the scope of the invention as defined by the appended claims. The foregoing description and drawings are, accordingly, to be regarded in an illustrative rather than a restrictive sense.

1. A method of treating a piping system carrying hydrocarbons to inhibit paraffin deposition, the method comprising:
injecting a catalyst fluid containing one or more scale forming compounds into the hydrocarbons carried by the piping system; and
inducing an electromagnetic field in hydrocarbons carried by the piping system, whereby the electromagnetic field causes formation of seed crystals of the scale forming compounds thereby causing paraffin to deposit on the seed crystals.

2. The method of claim 1 wherein the one or more scale forming compounds are selected from the group consisting of: calcium, carbonate, bicarbonate, calcium carbonate, calcium bicarbonate, and barium sulfide.

3. The method of claim 2 wherein the catalyst fluid is an aqueous solution.

4. The method of claim 1 wherein the catalyst fluid is an aqueous solution.

5. The method of claim 1 further comprising removing the paraffin deposits from the hydrocarbons.

6. The method of claim 5 wherein the one or more scale forming compounds are selected from the group consisting of: calcium, carbonate, bicarbonate, calcium carbonate, calcium bicarbonate, and barium sulfide.

7. The method of claim 6 wherein the catalyst fluid is an aqueous solution.

8. The method of claim 5 wherein the catalyst fluid is an aqueous solution.

9. The method of claim 5 wherein removing the paraffin deposits from the hydrocarbons includes filtration.

10. The method of claim 9 wherein the one or more scale forming compounds are selected from the group consisting of: calcium, carbonate, bicarbonate, calcium carbonate, calcium bicarbonate, and barium sulfide.

11. The method of claim 10 wherein the catalyst fluid is an aqueous solution.

12. The method of claim 9 wherein the catalyst fluid is an aqueous solution.

13. A hydrocarbon well comprising:
a casing disposed within a borehole;
production tubing disposed within the casing so as to define an annular space between the production tubing and the borehole, the production tubing further comprising:
at least one chemical injection mandrel; and
at least one chemical injection valve;
the at least one chemical injection mandrel and at least one chemical injection valve being adapted to inject a catalyst fluid containing one or more scale forming compounds into hydrocarbons carried by the production tubing; and
at least one electromagnetic treatment device coupled to the production tubing so as to induce an electromagnetic field therein, whereby the electromagnetic field causes formation of seed crystals of the scale forming compounds thereby causing paraffin to deposit on the seed crystals.

14. The hydrocarbon well of claim 13 wherein the one or more scale forming compounds are selected from the group consisting of: calcium, carbonate, bicarbonate, calcium carbonate, calcium bicarbonate, and barium sulfide.

15. The hydrocarbon well of claim 14 wherein the catalyst fluid is an aqueous solution.

16. The hydrocarbon well of claim 13 wherein the catalyst fluid is an aqueous solution.

17. The hydrocarbon well of claim 13 further comprising a chemical injection line from the chemical injection mandrel to the surface and disposed along the production tubing within the annular space between the production tubing and the borehole, the chemical injection line being a conduit for transport of catalyst fluid from the surface to the chemical injection mandrel.

18. The hydrocarbon well of claim 17 wherein the one or more scale forming compounds are selected from the group consisting of: calcium, carbonate, bicarbonate, calcium carbonate, calcium bicarbonate, and barium sulfide.

19. The hydrocarbon well of claim 18 wherein the catalyst fluid is an aqueous solution.

20. The hydrocarbon well of claim 17 wherein the catalyst fluid is an aqueous solution.

21. A piping system comprising:
a pipe containing a flow of hydrocarbon fluid;
one or more chemical injection points adapted to inject a catalyst fluid containing one or more scale forming compounds into the flow of hydrocarbon fluid carried by the pipe; and
one or more electromagnetic treatment devices coupled to the pipe so as to induce an electromagnetic field therein, whereby the electromagnetic field causes formation of seed crystals of the scale forming compounds thereby causing paraffin to deposit on the seed crystals.

22. The piping system of claim 21 wherein the one or more scale forming compounds are selected from the group consisting of: calcium, carbonate, bicarbonate, calcium carbonate, calcium bicarbonate, and barium sulfide.

23. The piping system of claim 22 wherein the catalyst fluid is an aqueous solution.

24. The piping system of claim 21 wherein the catalyst fluid is an aqueous solution.

25. A method of treating a piping system carrying hydrocarbons containing one or more scale forming compounds carried by the piping system to inhibit paraffin deposition, the method comprising:
inducing an electromagnetic field in hydrocarbons carried by the piping system, whereby the electromagnetic field causes formation of seed crystals of the scale forming compounds thereby causing paraffin to deposit on the seed crystals.
